(19) United States
(12) Patent Application Publication
(10) Pub. No.: US 2014/0164199 A1
(43) Pub. Date: Jun. 12, 2014

(54) INTEGRATING FINANCIAL ACCOUNTS WITH SOCIAL NETWORKING

(71) Applicant: GALILEO PROCESSING, INC., Salt Lake City, UT (US)

(72) Inventor: T. Clay WILKES, North Salt Lake, UT (US)

(21) Appl. No.: 13/945,872

(22) Filed: Jul. 18, 2013

Related U.S. Application Data
(60) Provisional application No. 61/673,120, filed on Jul. 18, 2012.

(51) Int. Cl. G06Q 50/00

(52) U.S. Cl. CPC G06Q 50/01; G06Q 40/02
USPC 705/35

(57) ABSTRACT

A computer-implemented method and system for integrating a financial account with at least one social networking account. A financial account to at least one user and may be assigned an identifier for the at least one social networking account. The identifier may, thus, be used to access information related to the financial account, to manage the financial account or to access funds in the financial account.

### CROSS-REFERENCE TO RELATED APPLICATIONS

This application claims priority to and the benefit of U.S. Provisional Application No. 61/673,120, filed Jul. 18, 2012, titled INTEGRATING FINANCIAL ACCOUNTS WITH SOCIAL NETWORKING, which is incorporated herein by reference in its entirety.

### TECHNICAL FIELD

Embodiments of the invention relate generally to integrating financial accounts with social networking services. More particularly, the invention relates to methods and systems for enabling consumers to make financial transactions using an account accessible using at least one social networking service.

### BRIEF SUMMARY

One embodiment is directed to a method of integrating a financial account with at least one social networking service. The method may include providing a financial account to at least one user and assigning an identifier for an account held on the at least one social networking service to the financial account to enable the at least one user to access the financial account using the identifier.

In another embodiment, a method processing a request related to a financial account is provided. The method may include receiving a request for information related to the financial account from a user via a communication from a client device, the request comprising an identifier for an account on at least one social networking service, correlating the identifier for the account on the at least one social networking service with the financial account and generating an electronic message comprising the information related to the financial account associated with the request.

In yet another embodiment, a system for financial processing is provided that may include a processor configured to receive a request for payment for a transaction from a client device, the request comprising an identifier for an account on at least one social networking service, correlate the identifier for the account on the at least one social networking service with a financial account and generate an electronic message comprising a code enabling payment for the transaction. The processor may also be configured to settle the payment for the transaction by, for example, communicating with an issuer of the financial account.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages will be set forth in the description which follows. The features and advantages of the invention may be realized and obtained by means of the instruments and combinations particularly pointed out in the appended claims. These and other features will become more fully apparent from the following description and appended claims.

### BRIEF DESCRIPTION OF THE DRAWINGS

To further clarify the above and other advantages and features of the present invention, a more particular description of the invention will be rendered by reference to example embodiments thereof which are illustrated in the appended drawings. It is appreciated that these drawings depict only example embodiments of the invention and are therefore not to be considered limiting of its scope. The invention will be described and explained with additional specificity and detail through the use of the accompanying drawings in which:

FIG. 1 is a block diagram illustrating an embodiment of a computing system means for integrating a financial account with a social networking service;

FIG. 2 is a flow diagram illustrating a method of integrating a financial account with a social networking service; and

FIG. 3 illustrates an example of a processing system means for implementing various aspects of the technology disclosed herein.

### DETAILED DESCRIPTION

Embodiments of the invention relate to methods and systems for integrating a financial account with one or more social networking services.

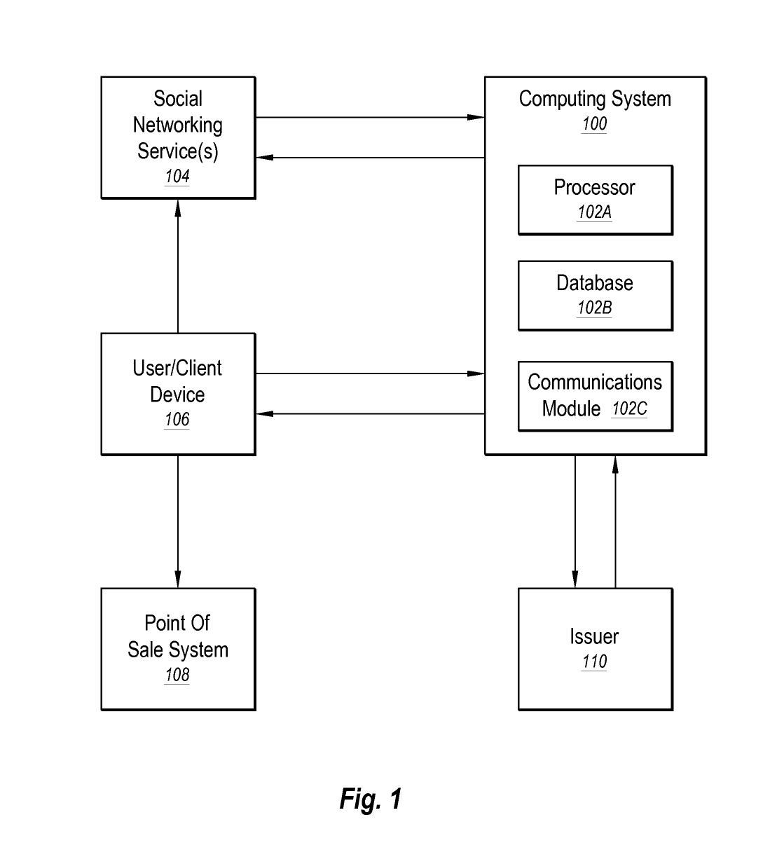

FIG. 1 is a block diagram illustrating an embodiment of a computing system 100 means for integrating a financial account with one or more social networking services 104. The term “social networking service” may refer to a social structure made up of individuals or entities, which are tied (connected) by one or more specific types of interdependency, such as friendship, kinship, common interest, financial exchange, dislike, sexual relationships, or relationships of beliefs, knowledge or prestige. Examples of such social networking services include, but are not limited to, FACEBOOK social networking service, MYSPACE social networking service and TWITTER social networking service. Users of such social networking services generally register for an account on the social networking service by providing contact information and personal information. Such social networking services may be accessed by users through one or more networks using, for example, a client device 106, such as a computer, a smartphone, a tablet computer, etc.

In these and other embodiments, the network may include the Internet, including a global internetwork formed by logical and physical connections between multiple wide area networks (WANs) and/or local area networks (LANs). Alternately or additionally, the network includes one or more cellular (radio frequency) RF networks and/or one or more wired and/or wireless networks such as, but not limited to, 802.xx networks, Bluetooth access points, wireless access points, IP-based networks, or the like. The network can also include servers that enable one type of network to interface with another type of network. The network may be accessed using, for example, compatible external applications (such as for smartphones), or by short message service (SMS).

FACEBOOK social networking service, for example, enables its users to create a web page including a personal profile, add other users such as friends, and exchange messages, including automatic notifications when they update their profile. Additionally, the users may join common-interest user groups, organized by workplace, school or college, or other characteristics, and categorize their friends into lists such as “People from Work” or “Close Friends.” The users may create profiles by uploading photos or entering personal information, such as personal interests, contact information, and other personal information. Facebook has a number of features with which users may interact. For example, the users may communicate with friends and other users through private or public messages as well as an instant messaging, or so-called “chat,” feature. The private messages may be delivered to and accessed via a personal inbox and the public messages may be posted to the user's web page or to a so-called, “wall” accessible via the web page. The users may respond to the messages accessible to them (e.g., public messages displayed on a wall or private messages in the user's inbox). The users may also create and join interest groups and “like pages,” some of which are maintained by organizations as a means of advertising.

MYSPACE social networking service also enables users to create web page with a personal profile.

TWITTER online social networking and microblogging service enables its users to send and read text-based posts of up to 140 characters, informally known as “TWEETS.” TWITTER has been compared to a web-based Internet Relay Chat (IRC) client. The user's posts or TWEETS are publicly visible by default; however, senders can restrict message delivery to just their followers. The users may subscribe to another user by registering to receive updates including that user's posts. This is referred to as “following” another user. The users may update their profiles by using the client device to transmit information over the network.

The term “social networking service,” as used, herein also encompasses so-called “social gaming services,” which may be a web-based game that is played with other individuals and may include online sharing of content that facilitates interaction between the individuals. The social gaming service may be built on a social networking service to integrate an online community with the social network. The social gaming services were developed as existing video games were revised to include social network integration and as social games were developed for use with existing social networks. Developers of social gaming services include, but are not limited to, ZYNGA, CROWDSTAR, PLAYDON and PLAYFISH. The games are generally strategy or role-playing games that take place through a social networking service, such as FACEBOOK or MYSPACE and involve multiple players. The players generally play through an online character or identity, such as by using a so-called “avatar.”

The computing system 100 can include a means for processing electronic data, such as a processing unit 102A, a means for storing information readable and accessible by the processing unit 102A, such as a database 102B, and a means for communicating with the Internet or a computer network, such as a communications module 102C. The computing system 100 includes software, such as an operating system, and other programs for performing the functions described herein.

The processing unit 102A may be any device capable of executing a set of instructions that specify actions to be taken. For example, the processing unit 102A may include a central processing unit (CPU). The processing unit 102A may be in communication with the database 102B, which stores computer-readable information or data. By way of example and not limitation, the processing unit 102A and the database 102B may include random access memory (RAM) or read only memory (ROM). The database 102B may, thus, include a computer-readable carrier medium that stores a computer-readable code (e.g., software) including a set of instructions that are performed when executed by the processing unit 102A during the methods described herein.

The computing system 100 may utilize the communications module 102C to enable communication between the processing unit 102A and the Internet or another computer network. The communications module 102C may include, for example, a modem, an ethernet card, a universal serial bus (USB) interface card, a wireless local area network (WLAN) or any other network device.

At least one financial account may be integrated with the social networking service 104 to enable the user to make purchases or obtain information related to the financial account using the social networking service 104. The financial account may be held by at least one user that is authorized to access and/or manage the financial account. For example, the user may be able to deposit funds in the financial account, withdraw funds from the financial account, utilize a line of credit associated with the financial account, etc. The financial account may be provided to the user and may be linked to an account on the social networking service 104 which is held by the user (i.e., a first social networking account). For example, the financial account may be issued to the user by an issuer 110, which may be a financial institution such as an issuing bank or credit union. The financial account issued to the user may be a bank account, such as a cash savings and/or checking account, a debit account or a line of credit, such as a credit card or loan. In some embodiments, the issuer 110 may manage or may be in communication with the computing system 100 to enable the exchange of information related to the financial account.

As previously discussed, the first social networking account may be obtained when the user registers with the social networking service 104 by providing contact information or other personal information. The social networking account may be assigned an identifier, such as a username, that enables the user to access the first social networking account. The username may be assigned to or selected by the user and may include the user's actual name, a name selected by the user, an email address for the user or any combination of letters, numbers and characters selected by the user.

The computing system 100 may receive information related to the user's financial account and the first social networking account and may assign and store the financial account in connection with the identifier for the first social networking account. In this way, the financial account may be linked to the identifier rather than to a financial account number. As a non-limiting example, the information related to the user's financial account may be transmitted to the computing system 100 from the issuer 110 of the financial account and may be received using the communications module 102C of the computing system 100. As another non-limiting example, the information related to the first social networking account may be transmitted from the social networking service 104 and/or from the client device 106 and may be received using the communications module 102C of the computing system 100.

The financial account may be linked to the identifier for the social networking service using, for example, the processor 102A of the computing system 100. The information related to the financial account for the user may be stored in association with the identifier of the first social networking account on, for example, the database 104.

Once the financial account is linked or associated with the identifier for the first social networking account, the identifier may be used to access funds from the financial account or to obtain information related to the financial account. For example, the user may use the identifier to make a purchase from a merchant, to check a balance of the account or to deposit funds to or withdraw funds from the account.

The computing system 100 may be configured to access messages on the social networking service 104. For example, the messages accessed by the computing system 100 may be email, text, microblog posts, or any other messages which may be sent using the social networking service 104. In some embodiments, the computing system 100 may have access to a second social networking account which may receive the messages (e.g., text-based posts) from users. The second social networking account may be held by an entity associated with the computing system 100, such as the issuer 110.

The user may send the message including the identifier for the first social networking account to the second social networking account. For example, the user may send a message including a request for funds or for information related to the financial account using the social networking service 104. As a non-limiting example, the user may post a message or a microblog entry to the second social networking account accessible to the computing system that includes the identifier for the first social networking account, which is integrated with the financial account held by the user.

The computing system 100 may receive the message from the user through the social networking service enabling the user to access the financial account. In some embodiments, the message may include a request for information related to the financial account. In other embodiments, the message may include a request to update or modify information related to the financial account. As a non-limiting example, the information related to the financial account may include at least one of an account balance, account activity, available funds, account preferences, personal information associated with the account, transaction history and/or account alerts.

For example, the user may send or post a message that includes the request for information and the identifier to the second social networking account. The identifier in the request may be matched with the financial account held by the user and the relevant information may be accessed and transmitted to the user. For example, processor 102A may match the identifier with the corresponding financial account by accessing information for the financial account stored on the database 102B. The processor 102A may then generate an electronic message, which may be transmitted to the user by the communications module 102C. The electronic message may be transmitted to the user on the client device 106, or may be transmitted to the user on the first social networking account held by the user.

In still other embodiments, the message may include a payment request for a purchase that is being made or that will be made by the user. For example, the user may send a message that includes the payment request and the identifier to the second social networking account. The identifier in the request may be matched with the financial account held by the user and, if sufficient funds or credit are available for the purchase, an access code may be generated and transmitted to the user. For example, processor 102A may match the identifier with the corresponding financial account by accessing information for the financial account stored on the database 102B. The processor 102A may then generate the access code, which may be transmitted to the user by the communications module 102C.

The access code may store information that enables access to the financial account, such as, enabling funds to be withdrawn from the financial account to pay for the purchase being made by the user. For example, the access code may include at least one of a quick response (QR) code, a barcode and an RFID. A “quick response” or “QR” code is a matrix barcode (or two-dimensional code) that is readable by dedicated readers and camera phones. The QR code may include black modules arranged in a square pattern on a while background. The information encoded in the QR code may include text, a URL or other data.

The message, which may include the access code, may be transmitted to the user through, for example, the client device 106. As a non-limiting example, the message may be transmitted to a mobile device or hand-held computer of the user. The message may be formatted for display on a screen of the client device 106.

In embodiments in which the user initiates a purchase from a merchant, the user may send a request for the access code enabling the purchase to the social networking service 104. The request may be received by the computing system 100, which may authorize the purchase. To authorize the purchase, the availability of funds or credit associated with the financial account may be determined. For example, the computing system 100 may access stored information related to the account, or may communicate with the issuer 110, to determine if the funds or credit associated with the account are sufficient to make the purchase from the merchant.

The access code may be generated and sent to the user and the user may present the access code to the merchant. For example, the merchant may use a point-of-sale system 108 that includes a reader configured to scan and read (i.e., decode) the access code. The merchant may communicate with the social networking service and/or the computing system 100 to complete the transaction. For example, the merchant may utilize a third social networking account held by the merchant on the social networking service, or another account accessible to the computing system 100 to initiate transfer of funds for the transaction made by the user. As a non-limiting example, the merchant may utilize the third social networking account to transmit a confirmation message to the computing system 100 by posting or transmitting a message to the second social networking account held by the entity associated with the computing system 100. Additionally or alternately, the computing system 100 may access a merchant financial account to settle the transaction. The computing system 100 may enable settlement of transaction by debiting the financial account for the amount of the payment. The merchant's financial account may then be credited with the amount of the payment.

Thus, the computing system 100 facilitates financial transactions using social networking services and codes scanner. Revenue may be generated by charging a fee for the service, such as, a fee per transaction or a monthly subscription fee.

The embodiments described herein may include the use of a special purpose or general-purpose computer including various computer hardware or software modules, as discussed in greater detail below.

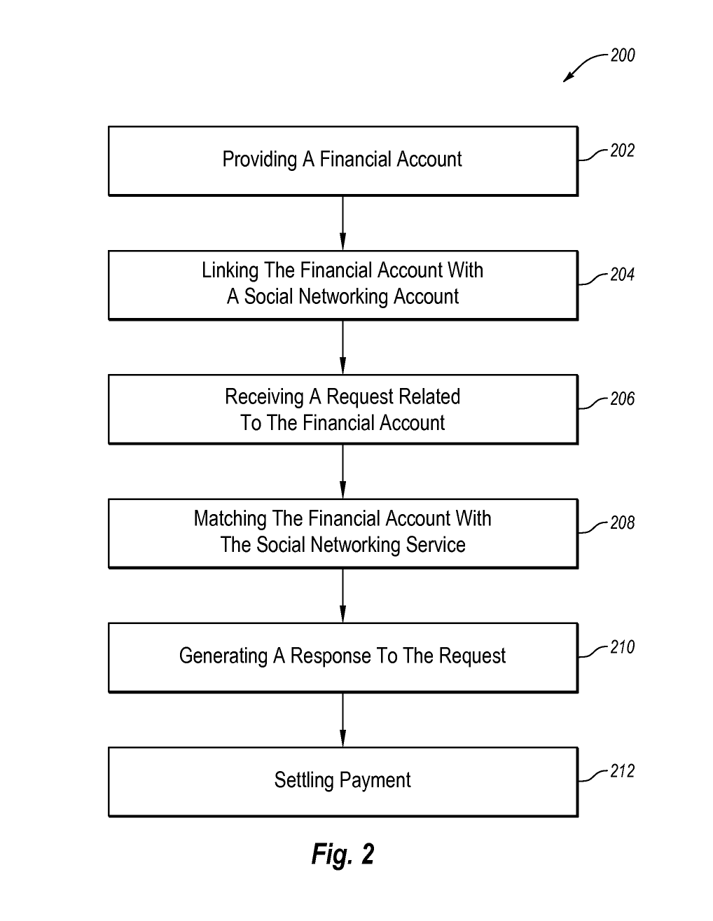

FIG. 2 is a flow diagram illustrating an embodiment of a method 200 of enabling financial transactions by integrating a financial account with a social networking service. The method 200 may include providing a financial account 202 to an account holder. The account holder may be a user of the account, such as an individual or an entity. Information related to the financial account may be stored or accessed by the computing system 100 of FIG. 1 and may be provided by the issuer 110.

The method 200 may also include linking the financial account with a social networking account 204. As a non-limiting example, the financial account may be linked to an account held by the holder of the financial account. The financial account may be associated with an identifier for the social networking account, such as a username. More than one social networking account (such as accounts held on different social networking services) may be linked to the financial account. Utilizing the identifier of the social networking account as a access code for the financial account may enable access to the financial account without the use of conventional numbers.

The method 200 may also include receiving a request related to the financial account 206, the request including the identifier for the social networking account. The request may include, for example, a request for information related to the financial account or a request for payment for a transaction in which the financial account will be used to pay for goods and/or services. The request may be received, for example, by the processor 102A of the computing system 100 of FIG. 1 using the communications module 102C.

The method 200 may also include matching the financial account with the social networking account 208. For example, the financial account may be correlated with the social networking account using the identifier for the social networking account, which links the financial account to the social networking account. The processor 102A of the computing system 100 of FIG. 1 may access information related to the financial account, which may be stored on the database 102B. Once the financial account has been matched with the social networking account, the request may be processed to access the requested financial information or to provide authorization for at least one purchase. For example, if the request includes account activity, such as a deposit, withdrawal or transfer of funds, the activity may be processed. For example, the request may be processed using the processor 102A of the computing system 100 of FIG. 1.

The method 200 may also include generating a response to the request 210 that includes, for example, the requested financial information of purchase authorization. In examples in which the request includes a request for information related to the financial account, the response may be an electronic message that includes text data reflecting the requested financial information. In examples in which the request includes account activity, the response may be an electronic message that includes text data reflecting the activity, such as previous and current account balance, available funds, amount transferred, deposited or withdrawn. In examples in which the request includes an authorization request for a purchase, the response may include payment authorization in the form of a code, such as a QR code. The code may be presented to the merchant to complete purchase.

In embodiments in which the method 200 may also include settling payment 212 by transferring funds for the purchase from the financial account to the merchant or an account held by the merchant.

The consumer may use a payment medium, such as a credit card or debit card, to make the purchase from the merchant. The incentive information is transmitted to a trusted authority, where it may be received and stored 202 as computer-readable data using a system, such as the computing system 100 shown in FIG. 1. For example, the incentive information may be received by the trusted authority using, for example, the processing unit 102 of the computing system 100 and may be stored as a first set of data on computer-readable medium, such as that of the database 104 of the computing system 100.

A transaction may take place between the consumer and a merchant wherein the consumer purchases the particular item for which the incentive is offered from the merchant. The merchant or the consumer may transmit information pertaining to the transaction, including product level data (e.g., a SKU number or UPC code), to the trusted authority. The trusted authority may receive and store 204 the transaction information as a second set of data using, for example, the processing unit 102 and the database 104 of the computing system 100 shown in FIG. 1.

Optionally, the trusted authority may request payment verification 206 (shown in broken lines) for the transaction from the issuer of the payment medium used by the consumer in the transaction. For example, the verification request may be generated and transmitted to the issuer of the payment medium using the processing unit 102 and the communications module 106 of the computing system 100 shown in FIG. 1.

The transaction information may then be compared 208 with transaction records held by the issuer to verify the transaction using, for example, the processing unit 102 of the computing system 100 shown in FIG. 1. Accessing and comparing this information provides the trusted authority with ability to verify whether the transaction took place, thus preventing fraudulent or mistaken reporting of transactions.

The product level data corresponding to one or more items purchased in the transaction (e.g., the second set of data) may then be matched 210 against the incentive information (e.g., the first set of data) to determine if the consumer qualifies for the incentive from the sponsor. For example, using the processing unit 102 of the computing system 100 shown in FIG. 1, the product level data (e.g., a SKU number) may be compared with incentive information (e.g., SKU numbers) stored on the database 104.

If the product level data corresponds to that specified by the sponsor in association with the incentive (e.g., the first set of data and the second set of data include common product identifiers) the trusted authority may, optionally, notify 212 the sponsor that the consumer is entitled to the incentive (shown in broken lines). The trust authority may notify the sponsor using any means of communication. As a non-limiting example, the trust authority may generate an electronic notification using the processing unit 102 of the computing system 100 shown in FIG. 1 and may transmit the electronic notification to the sponsor using the communications module 106 of the computing system 100 shown in FIG. 1.

The incentive may then be provided 214 to the consumer by the trusted authority, the sponsor or the social networking or gaming service for which the consumer holds an account. In some embodiments, the trusted authority may provide the incentive to the consumer by applying a credit directly to the payment account used by the consumer in the transaction. In other embodiments, the trusted authority may notify the social networking or gaming service that the consumer is entitled to the incentive, or may linked to the social networking or gaming service such that the trusted authority may directly provide the incentive to the consumer via the social networking or gaming service. For example, the trusted authority may be linked to the social networking or gaming service via the communications module 106 of the computing system 100 shown in FIG. 1, and the processing unit 102 may be used to provide the incentive to the consumer's account with the social networking or gaming service.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a physical network or another physical communications connection to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated.

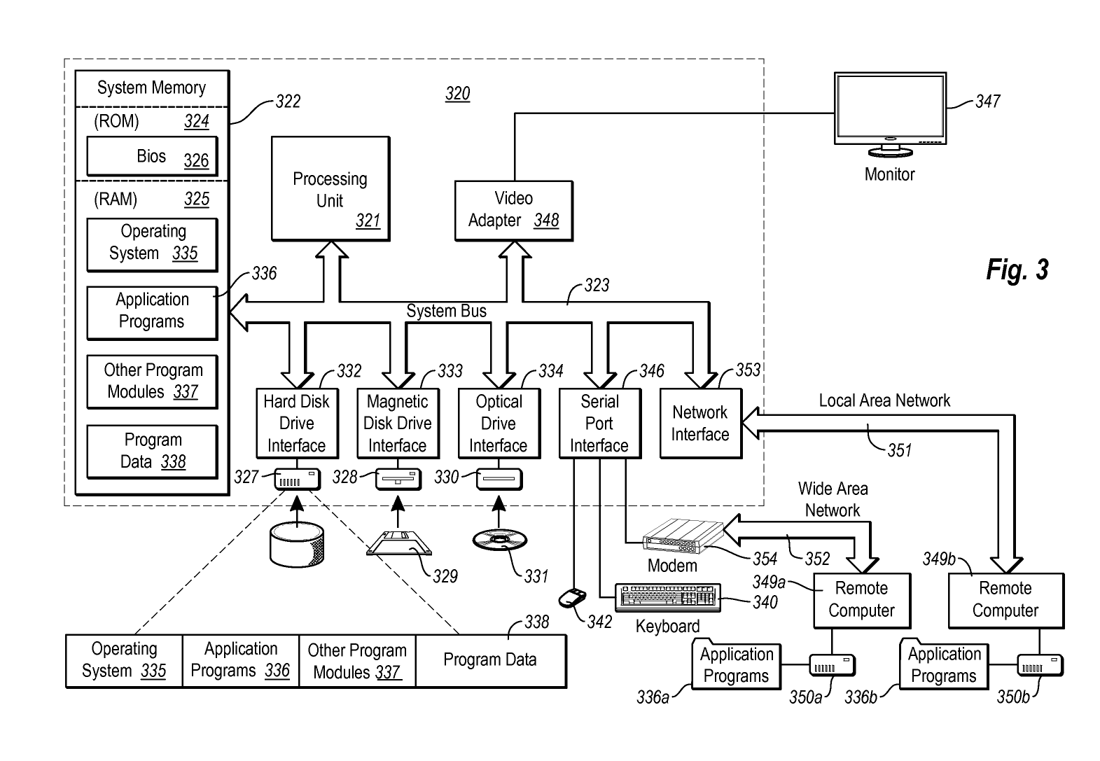

With reference to FIG. 3, an example of a processing system for implementing at least portions of the technology herein includes a general purpose computing device in the form of a computer 320. Components of computer 320 may include, but are not limited to, a processing unit 321, a system memory 322, and a system bus 323 that couples various system components including the system memory to the processing unit 321. The system bus 323 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Processing means, such as computer means 320 or the processor of mobile phone, tablet PC, or other processing device typically includes a variety of computer readable media. Computer readable media can be any available media that can be accessed by computer 320 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible means or medium which can be used to store the desired information and which can accessed by computer 310.

Referring still to FIG. 3, the system memory 322 includes computer storage media in the form of volatile and/or nonvolatile memory such as read only memory (ROM) 324 and random access memory (RAM) 325. A basic input/output system 326 (BIOS), containing the basic routines that help to transfer information between elements within computer 320, such as during start-up, is typically stored in ROM 324. RAM 325 typically contains data and/or program modules that are immediately accessible to and/or presently being operated on by processing unit 321. By way of example, and not limitation, FIG. 34 illustrates operating system 335, application programs 336, other program modules 337, and program data 338.

The computer 320 may also include other removable/non-removable, volatile/nonvolatile computer storage media. By way of example only, FIG. 3 illustrates a hard disk drive 327 that reads from or writes to non-removable, nonvolatile magnetic media, a magnetic disk drive 328 that reads from or writes to a removable, nonvolatile magnetic disk 329, and an optical disk drive 330 that reads from or writes to a removable, nonvolatile optical disk 331 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 327 is typically connected to the system bus 323 through a non-removable memory interface such as interface 332, the magnetic disk drive 333 is typically connected to the system bus 323 by a removable interface, such as interface 333, and the optical disk drive is typically connected to the system bus 323 by a removable interface, such as interface 334.

The drives and their associated computer storage media discussed above and illustrated in FIG. 3 data for the computer 320. In FIG. 3, for example, hard disk drive 332 is illustrated as storing operating system 335, application programs 336, other program modules 337, and program data 338. Note that these components can either be the same as or different from operating system 335, application programs 336, other program modules 337, and program data 338. Operating system 335, application programs 336, other program modules 337, and program data 338 are given different numbers here to illustrate that, at a minimum, they are different copies. A user may enter commands and information into the computer 320 through input devices such as a keyboard 340 and pointing device 342, commonly referred to as a mouse, trackball or touch pad. Other input devices (not shown) may include a microphone, joystick, game pad, satellite dish, scanner, or the like. These and other input devices are often connected to the processing unit 321 through a user input interface 346 that is coupled to the system bus, but may be connected by other interface and bus structures, such as a parallel port, game port or a universal serial bus (USB). A monitor 347 or other type of display device is also connected to the system bus 323 via an interface, such as a video interface 348. In addition to the monitor 348, computers may also include other peripheral output devices such as speakers and printer, which may be connected through an output peripheral interface.

The computer 320 may operate in a networked environment using logical connections to one or more remote computers, such as remote computers 349a and 349b. The remote computers 349a and 349b may be a personal computer, a server, a router, a network PC, a peer device or other common network node, and typically includes many or all of the elements described above relative to the computer 320, although only memory storage devices 350a and 350b have been illustrated in FIG. 3. The logical connections depicted in FIG. 3 include a local area network (LAN) 351 and a wide area network (WAN) 352, but may also include other networks. Such networking environments are commonplace in offices, enterprise-wide computer networks, intranets and the Internet.

When used in a LAN networking environment, the computer 320 is connected to the LAN 352 through a network interface or adapter 353. When used in a WAN networking environment, the computer 320 typically includes a modem 354 or other means for establishing communications over the WAN 352, such as the Internet. The modem 354, which may be internal or external, may be connected to the system bus 323 via the user input interface 346, or other appropriate mechanism. In a networked environment, program modules depicted relative to the computer 320, or portions thereof, may be stored in the remote memory storage device. By way of example, and not limitation, FIG. 3 illustrates remote application programs 336a and 336b as residing on memory device 350a and 350b. It will be appreciated that the network connections shown are exemplary and other means of establishing a communications link between the computers may be used.

Explanation of the Internet, computers, and networks can also be understood by reading “How the Internet Works” seventh ed. by Preston Gralla (2004) Que Publishing, “How Networks Work”, seventh ed. by Frank Derfler Jr. and Les Freed (2005) Que Publishing, and “How Computers Work” seventh ed. by Ron White (2004) Que Publishing, the contents of all three books are hereby incorporated by reference herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of integrating a financial account with at least one social networking service, comprising:
providing a financial account to at least one user; and
assigning an identifier for an account held on the at least one social networking service to the financial account to enable the at least one user to access the financial account using the identifier.

2. The method of claim 1, wherein providing a financial account to at least one user comprises providing at least one of a bank account and a line of credit to the at least one user.

3. The method of claim 2, wherein assigning an identifier for an account held on at least one social networking service to the financial account comprises assigning a username for the account held on the at least one social networking service to the financial account.

4. The method of claim 1, further comprising receiving a message from the at least one user through the at least one social networking service to enable the at least one user to access the financial account.

5. The method of claim 1, further comprising generating a code enabling access to the financial account, the code comprising at least one of a quick response code and a barcode.

6. The method of claim 5, further comprising transmitting the code to a mobile device of the at least one user in a format enabling display of the code on a screen of the mobile device.

7. The method of claim 1, wherein assigning an identifier for an account held on at least one social networking service to the financial account comprises assigning the identifier for an account held by the at least one user on at least one social networking service to the financial account.

8. The method of claim 1, further comprising matching the identifier contained in a message with the financial account provided to the at least one user, the message comprising a request for information related to the financial account.

9. A method of processing a request related to a financial account, comprising:
receiving a request for information related to the financial account from a user via a communication from a client device, the request comprising an identifier for an account on at least one social networking service;
correlating the identifier for the account on the at least one social networking service with the financial account; and
generating an electronic message comprising the information related to the financial account associated with the request.

10. The method of claim 9, wherein correlating the identifier for the account on the at least one social networking service with the financial account comprises using a processor to correlate the identifier for the account on the at least one social networking service.

11. The method of claim 8, wherein the identifier is not a financial account number.

12. The method of claim 8, wherein the payment request comprises a text-based post on a webpage of the social networking service.

13. The method of claim 8, wherein generating an electronic message comprising the information related to the financial account associated with the request comprises generating the electronic message comprising a quick response code comprising information for accessing the account.

14. The method of claim 13, wherein generating the electronic message comprising a quick response code comprising information for accessing the account comprising generating the quick response code storing information enabling a payment to be made from the financial account.

15. The method of claim 9, further comprising accessing the information related to the financial account associated with the request.

16. The method of claim 9, wherein receiving a request for information related to a financial account from a user comprises receiving a request for payment authorization.

17. A system for financial processing, comprising:
a processor configured to:
receive a request for payment for a transaction from a client device, the request comprising an identifier for an account on at least one social networking service;
correlate the identifier for the account on the at least one social networking service with a financial account; and
generating an electronic message comprising a code enabling payment for the transaction.
